(19) United States
(12) Patent Application Publication
(10) Pub. No.: US 2008/0319682 A1
(43) Pub. Date: Dec. 25, 2008

(54) Method and System For Operating In-Situ (Sampling) Chemical Sensors

(76) Inventors: Stephen Keith Holland, Crozet, VA (US); Gabriel Laufer, Charlottesville, VA (US); Gregory C. Lewin, Odense (DK); Roger L. Reynolds, Charlottesville, VA (US); Jason D. Baker, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(21) Appl. No.: 12/162,559

(22) PCT Filed: Jan. 30, 2007
(86) PCT No.: PCT/US07/02581

§ 371 Date: Jul. 29, 2008

Related U.S. Application Data
(60) Provisional application No. 60/763,619, filed on Jan. 31, 2006.

(51) Int. Cl. G06F 19/00

(52) U.S. Cl. 702/24

(57) ABSTRACT

A system and method of alternately purging an in-situ sensor with clean fluid and sampling a fluid volume of interest, in order to eliminate drifts and errors associated with the absorption of chemicals to the sensing elements of in-situ sensors. The system and method effectively processes the output of the in-situ sensor using this alternating sample and purge cycle to detect and identify chemicals accurately and reliably. The system and method also effectively reduce errors induced by temperature and humidity drifts in the ambient, and the sampled, fluid.

### CROSS-REFERENCE TO RELATED APPLICATIONS

The present invention claims priority under 35 U.S.C. §119(e) of the earlier filing date of U.S. Provisional Application Ser. No. 60/763,619, filed Jan. 31, 2006, entitled “Method and System for Operating In-Situ (Sampling) Chemical Sensors” the disclosure of which is hereby incorporated by reference herein in its entirety.

### GOVERNMENT SUPPORT

Work described herein was supported by Federal Grant No. W91 CRB-04-C-0026, awarded by The Technical Support Working Group (TSWG). The Government has certain rights in this invention.

### BACKGROUND OF THE INVENTION

Numerous technologies have been developed for detecting and identifying gaseous chemicals. In order to protect building ventilation systems in facilities such as airports, chemical plants, stadiums, and military bases from deliberate or accidental release of toxic chemicals, an in-situ chemical sensor, also known as a sampling or point chemical sensor, may be utilized. An in-situ sensor must have physical contact with the tested air and with the toxic chemicals to provide protection. This is in contrast to remote or open path chemical sensors that can detect chemicals, often by optical means, without physical contact. In-situ devices often rely on drawing air, or other fluids, from the sampled environment on a continuous or intermittent basis. The sampled air, or fluid, may be tested in a number of ways to determine the presence or threat of toxic chemicals. By way of illustration, it may be passed through ionization or combustion chambers from which the ionized or burned gas is further analyzed. In another example it may be passed across an array of polymers that are specifically designed to selectively absorb chemicals of interest (e.g., a toxic chemical which is to be detected by the sensor). As chemicals of interest are absorbed by such polymers in this array, physical properties of the polymer material, such as its electrical resistance, electrical capacitance, or resonant acoustic oscillation frequency, exhibit changes. Measuring any or all of these changes relative to an unexposed (or baseline) condition that may be recorded prior to absorbing the chemical of interest provides an indication of the chemical presence and a measure of the concentration or quantity of the chemical at the sample location. By measuring the response of multiple polymers within the array, each having a different affinity to different chemicals, it is possible to obtain a signature or fingerprint that is specific to each chemical and that can be used for identification.

Once the array of the various polymers has been exposed to a certain chemical, that chemical remains absorbed to the absorbing polymers for extended periods of time, often until a new sample is drawn. But even if the new sample that is drawn through the array no longer contains that chemical, some or all of its molecules that were originally absorbed remain attached to the polymer for long periods of time, as the desorption of the chemical from the polymer is a slow process. Since the ability of the polymers of the array to absorb molecules of any kind is limited, once molecules are absorbed and until they desorb, the polymers of the array may become less sensitive to future chemical exposures because their dynamic range, i.e., the range of measurable physical change due to chemical presence, is reduced and the array cannot be used to reliably detect future chemical exposures until the chemical (or chemicals) that are already absorbed have completely desorbed and the polymers return to their original uncontaminated (or baseline) state. Such a process that reduces the detection sensitivity of the polymers is called “poisoning.” In-situ sensors may be poisoned by high concentrations of the gases that they were designed to detect.

Additionally, such absorbing polymers have been shown to exhibit sensitivity to environmental conditions. In particular, water vapor readily absorbs to many polymer materials that are used for commercially available sensors. Thus, water vapor, pollutant hydrocarbons, carbon dioxide (CO₂), NOₓ, or other gases that may be present in ordinary or polluted environments may also poison many in-situ sensors. To illustrate, if the absolute humidity of the sampled air passing over the polymer array varies over time or from location to location, large drifts in the baseline state may be measured, thereby reducing the detection sensitivity. Additionally, the absorption of water or other pollutants by the polymers reduces the sensitivity of some of the polymer elements of the array to chemicals of interest, for example, by decreasing the surface area or bulk available for chemical absorption. Changing the sensitivity of some of the elements by absorption of background gases, such as water vapor, may result in an inconsistent measured output following chemical exposure. Such inconsistency may prevent detection of the chemical or may lead to incorrect identification.

Further, it has been found that such polymers are sensitive to the environmental temperature. Changes in the ambient temperature or the temperature of the polymers may also be exhibited as a baseline drift. Such baseline drifts may be of magnitudes that are significantly larger than the changes induced by a chemical of interest. Furthermore, drifts induced by variations in the environmental temperature or temperatures of the array polymers may induce drifts in the responses that are of different magnitudes for each absorbing polymer in the polymer array. These large magnitude baseline variations make detection and identification of chemicals difficult when air, which in realistic conditions may vary in absolute humidity and temperature (for example, in an HVAC system), is continuously sampled by such an in-situ device. Further, such variations completely mask the responses of the polymer array to any persistent low-concentration chemical presence.

There is also evidence to suggest that extended exposure to atmospheric chemicals, aerosols (e.g., dust), and water vapor may degrade the polymer sensitivity to chemicals over time. Such extended exposure may also interfere with normal operation of other components that are commonly used by in-situ sensors such as filters, concentrating elements, or drift tubes. Other results show that continuous exposure of these polymers to chemicals that often occur in the environment, e.g., water vapor or other pollutants, may induce changes in the calibration characteristics of such sensors thereby periodically requiring new calibration.

### BRIEF SUMMARY OF INVENTION

Some aspects of various embodiments of the present invention provide, but not limited thereto, a system and a method in which drifts and errors associated with the absorption of chemicals to the sensing elements of in-situ sensors are eliminated and a well-defined and reproducible baseline is established before each measurement. Some aspects of various embodiments of the present invention also provide, but not limited thereto, a reduction in the errors induced by temperature, humidity, and pollutant level variations in the ambient, and the sampled, gas. The system and method allows for in-situ sensors, which may consist of surfaces or bulks that selectively absorb chemicals for the purpose of detecting the chemicals and/or measuring their concentrations, or may include drift tubes, concentration elements, ionization chambers, combustion chambers, or filters to be purged by gases that are free from those chemicals that can absorb to the sensing elements of the sensors or interfere with its other components. During the purge period, the polymers release much, or all, of the chemicals that they absorbed previously. Similarly, purging may either remove contaminations from the other components of in-situ sensors or simply extend their operating life. By releasing all or some of the absorbed chemicals the sensing elements and their accessories are restored, completely or partially, to their unperturbed state. In this state, each sensing element provides an output that is at or near a baseline or zero level. Depending on the type of sensor, if the sensor is used to detect gases, the gases that are used to purge the sensing elements may be noble gases such as helium or argon, inert gases such as nitrogen, compressed dry air, or ambient air that was drawn through a desiccating column and/or a purifying column such as an activated charcoal filter. Generally, the purge gas can be any gas that does not contain chemicals or aerosols that can absorb to the sensing elements, clog its components, or interfere with their operation, or any gas where the concentration of such chemicals has been reduced.

The purge period may be of fixed or indefinite duration. However, since the rate of chemical desorption from the array elements may vary with the chemicals or pollutants absorbed in the elements, a consistent and repeatable baseline state may be obtained with a predetermined and fixed purge cycle duration that allows a majority of the chemicals to be desorbed. If an indefinite purge duration is employed, it may be necessary to parameterize the desorption rates for various chemicals and pollutants and use this information to correct the baseline for varying purge period durations.

After a purge period, the sensor is switched into sampling mode. In that mode, the sample is drawn from the test area and passed through the in-situ sensor, through some or all of its accessories, or through or over the sensing elements. After a preset or indefinitely long sampling period the sensor is switched back into the purge mode. As with the purge cycle, since the rate of chemical absorption or desorption from the sensor components or from the array elements varies with the chemicals or pollutants absorbing or desorbing from the elements, it is preferable to sample for a preset time period to obtain a repeatable array response. If an indefinite sample cycle duration is employed, it may be necessary to parameterize these absorption and desorption rates for each expected chemical and pollutant for every element of the array and use this information to correct the sample data for the varying sample times. The purge-sample cycle may be repeated as often as needed or may be performed only once.

In one embodiment of the purge cycle, air, or other fluid, from either the volume of interest or from an external volume, which may or may not contain a chemical of interest and may or may not contain water vapor, is pulled through a cleaning column by a pumping mechanism that may be either internal to the in-situ device or external to the device. This cleaning column contains a desiccating material intended to remove water vapor from the incoming air, or other fluid, and a filtering material, such as activated charcoal, intended to remove atmospheric pollutants, such as hydrocarbons, and chemicals of interest from the incoming air, or other fluid. Other combinations of filters that are intended to remove humidity, pollutants, and other potentially absorbing molecules and particulates from the purge gas, or fluid, can also be used. After passing through this column, all chemicals of interest are removed from the fluid flow and the purge fluid contains only a small concentration of water vapor and only a small concentration of other contaminants or pollutants. This cleaned and dried air, or fluid, is then passed through the in-situ sensor or over the sensing array either for a predetermined and set time period or for an indefinite time period. At the end of this time period, the physical (or electrical) responses, also called the signals, of the sensing elements in the array are measured, recorded, and stored. Following this clean purge cycle, the device then enters the sample mode.

In the sample mode, air, or other fluid, from the volume of interest, which may or may not contain a chemical of interest but may contain some humidity or pollutants, is drawn over the sensor elements of the array with a pump that may be imbedded in the in-situ detection device or may be external to the device. The air is passed over the sensing elements of the array for a predetermined and set time period, which may be shorter than the purge cycle time period, to allow the polymers to absorb and provide a measurable response to the chemicals and/or the water vapor in the sampled volume. At the end of the preset sample time period, the signals from the polymer array are measured, processed, and stored. The purge-sample cycle response of the polymer array is then computed as the difference between the sample and purge cycle signals or as the normalized difference between the sample and purge cycle signals.

Next, the device again enters the purge step, where cleaned and dried air, or other fluid, is passed through the in-situ sensor or over the sensing element array. During this purge step, water vapor and any other chemical absorbed by the sensing elements array are desorbed from the polymers and the response of the sensing elements is again recorded. Following the second purge cycle, the device enters another sample step and the array response at the end of that sample step is recorded. A second purge-sample cycle response is computed. This sample and purge cycling continues indefinitely or for a preset number of cycles.

Ideally, for example, the first one or more purge and sample cycles occur with no chemical of interest present in the sampled fluid volume. In this manner, the first purge-sample cycle response serves as a reference to which the results of future cycles are compared, as it represents the purge-sample cycle response to humidity or other pollutants. For detection and identification of chemicals, the difference between this first purge-sample cycle response and the second purge-sample cycle response (or the normalized difference) is computed. In most applications, the absolute humidity and/or other pollutant concentrations are expected to vary slowly with time; therefore, if there is no chemical of interest present during subsequent purge-sample cycles, the changes in the response will be of a small magnitude or will be recognized by the signature as belonging to water vapor or other pollutants. When this occurs, the new purge-sample cycle response is stored as a new reference to which future results are compared. If environmental variations are large, it is possible to employ mathematical methods such as linear projection or a non-linear iterative technique to subtract or null the effect of such water vapor or pollutant concentration changes. If a chemical of interest is present in the sampled air, the purge-sample response will be distinctive from that of water or the other pollutants thereby indicating the presence of the chemical of interest. The response of the absorbing polymers in the array is compared to a library of stored chemical responses to identify the chemical of interest. Prior to comparison to the response library, the effect of the water vapor or pollutant change on the polymer array response may be removed by using a mathematical projection technique, thus providing a higher probability of correctly identifying the chemical.

In all the embodiments of this invention (or alternatively in select embodiments), it may be desirable to control the temperature of both the sample and the purge fluids or to allow the temperature of both the sample and the purge fluids to equilibrate with the environment before entering the sensor thereby reducing the effects of temperature drifts. The temperature can be controlled by drawing the fluids through a device that includes temperature controllers (heating and/or cooling) that allow the temperature of the fluids to reach a predetermined temperature. The temperature can also be equilibrated with the environment by drawing the fluid (purge or sample) through a long tube that is located at or near the monitored environment. It may also be desirable to control the temperature of all the sensing elements and/or the entire sensor, which may be done by including a temperature control device (heating and/or cooling), thereby reducing the effects of temperature drifts.

An aspect of an embodiment of the present invention provides a detection system for detecting chemicals in fluids. The system may comprise at least one in-situ sensor comprised of one or more detection elements adapted to detect at least one chemical; a purge fluid input means, wherein the purge fluid can be inputted into the sensor either for a predetermined and set time period or for an indefinite time period; a sampling input means, wherein the sample fluid of interest can be inputted into the sensor either for a predetermined and set time period or for an indefinite time period; and a means for alternating between a purging period and a sampling period.

An aspect of an embodiment of the present invention provides a method for detecting chemicals. The method may comprise the following steps: in-situ monitoring a fluid volume for detecting at least one chemical; purging during a purging period, wherein the duration of the purging period is either a predetermined and set time period or an indefinite time period; sampling from the fluid volume of interest during a sampling period, wherein the duration of the sampling period is either a predetermined and set time period or an indefinite time period; and switching between the purging period and the sampling period to create a purge-sample cycle, wherein the purge-sample cycle can repeat any number of times.

An aspect of an embodiment of the present invention provides a system and related method of alternately purging an in-situ sensor with clean fluid and sampling a fluid volume of interest, in order to eliminate drifts and errors associated with the absorption of chemicals to the sensing elements of in-situ sensors. The system and method effectively processes the output of the in-situ sensor using this alternating sample and purge cycle to detect and identify chemicals accurately and reliably. The system and method also effectively reduce errors induced by temperature and humidity drifts in the ambient, and the sampled, fluid.

These and other objects, along with advantages and features of various aspects of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 is a schematic illustration of an exemplary embodiment of the present invention.

FIG. 2 is a graphical representation of an example response of a single chemiresistor from exposure to a chemical of interest.

FIG. 3 is a graphical representation of the response of a chemiresistor to air varying in temperature and absolute humidity. Ammonia, which represents a chemical to be detected was introduced at approximately 2000 s.

FIG. 4 is a graphical representation of the response of a 32-polymer array operated in continuous sample mode to the ammonia introduced into air at different environmental conditions.

FIG. 5 is a graphical representation of the response of a 32-polymer array operated in purge-sample mode to the ammonia introduced into air at different environmental conditions.

### DETAILED DESCRIPTION OF THE INVENTION

In-situ sensors, such as an electronic nose (ENose) or a surface acoustic wave device (SAW), often draw air from the sampled environment across an array of sensing elements such as certain polymers that are specially designed to selectively absorb chemicals of interest. Some of the physical properties, such as the electrical resistance, electrical capacitance, or acoustic resonant oscillation frequency, of the sensing elements in this array exhibit changes as they absorb the chemicals of interest. Measuring these changes compared to the unexposed (baseline) condition prior to absorbing the chemical provides an indication of the presence and quantity of the chemical of interest at the sample location.

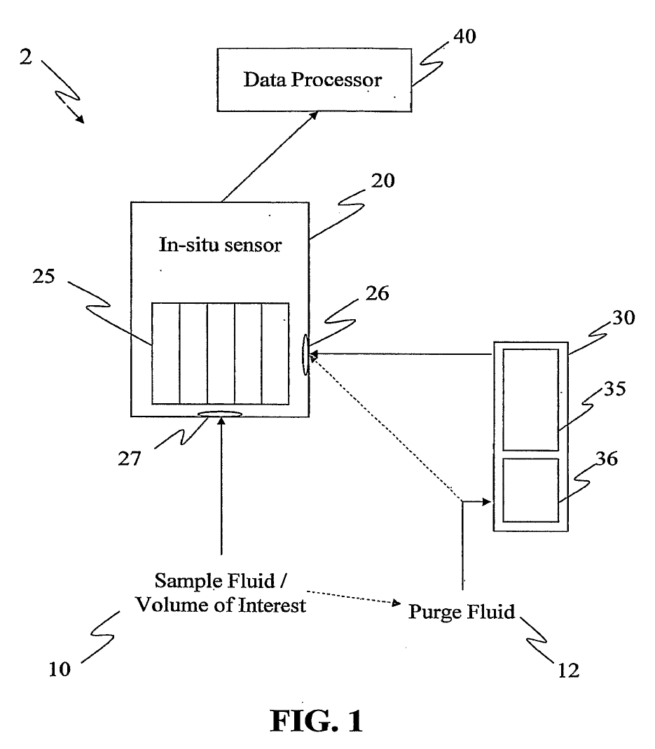

An exemplary embodiment is provided in the schematic block diagram of FIG. 1. FIG. 1 illustrates an aspect of an embodiment of the present invention detection system 2 and related method comprising at least one in-situ sensor 20 comprised of one or more detection elements 25, a purge input 26, and a sample input 27. The exemplary embodiment further comprises at least one data processor 40 adapted to receive data from the in-situ sensor 20. The present invention detection system and method 2 operates by alternating between purge periods and sample periods. During the purge period, purge fluid 12 is inputted into the in-situ sensor 20 through the purge input 26. The purge fluid 12 can be inputted into the in-situ sensor 20 either for a predetermined and set time period or for an indefinite time period. In the embodiment of FIG. 1, a clean dry air flow for purging may be achieved by passing ambient air, either from the sampled volume 10 or from a different volume, through a scrubbing column 30 containing a layer of desiccant 35 (to remove water vapor) and a layer of activated charcoal filter 36 (to remove chemical contaminants). During the sample period, the volume of interest 10 is inputted into the in-situ sensor 20 through the sample input 27. The volume of interest 10 can be inputted into the in-situ sensor 20 either for a predetermined and set time period or for an indefinite time period. The data processor 40 analyzes data from the purge and sample periods. The various embodiments of the present detection system and method 2 allow for different analytical techniques that the data processor 40 may follow in analyzing the data from the purge and sample periods.

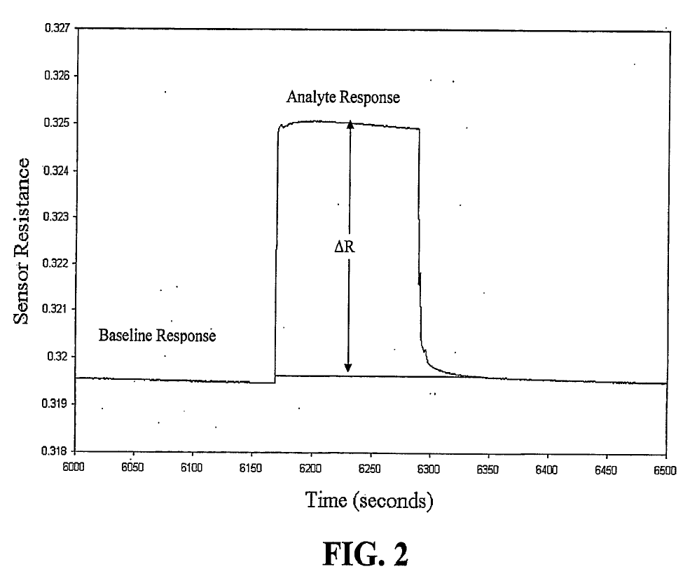

Turning to FIG. 2, FIG. 2 shows an example of such a time dependent response to chemicals obtained from a single sensing element of one example of an ENose in-situ sensor made by Smiths Detection, the Cyranose 320, which uses chemiresistor technology. Under well controlled laboratory conditions, the electrical resistance of the polymer is at a baseline level. When the polymer substrate (or sensor) absorbs a chemical of interest, e.g., at time 6150 s in FIG. 2, the polymer swells and results in an increase in the electrical resistance. The magnitude of this resistance change may provide a measure of the chemical concentration. After the chemical was removed from the air sampled by the sensor (approximately at a time of 6300 s) the chemical of interest that originally absorbed to the sensing element is desorbed and the polymer resistance returns to its original baseline response state.

The sensor response to the chemical of interest is considered to be the difference between the baseline resistance state (baseline response) and the resistance of the polymer after sufficient chemical exposure (response to the chemical of interest), ΔR. Alternatively, to obtain a fractional resistance change due to the chemical presence, this difference measure may be normalized (divided by) the initial baseline response, prior to chemical exposure, providing a net normalized response, ΔR/R. By measuring the response of multiple polymers within the array, each having a different affinity to different chemicals, it is possible to obtain a chemical signature or “fingerprint” that can be used to identify the chemical of interest. If the baseline reading is reproducible, then ΔR/R becomes a reproducible measurement that will repeat itself whenever the exposure contains the same chemical at the same concentration.

However, since the polymer array is designed to provide excellent absorption of the chemicals of interest, once the array has been exposed to a chemical, the chemical remains absorbed in the polymers for long periods of time as the desorption of the chemical from the polymer is a slow process, i.e., a polymer responds at a different rate depending on the chemical transfer process (absorption or desorption). This is illustrated by the long exponential decay from the response to the chemical of interest to the original baseline resistance response in FIG. 2. As the figure shows, recovery time may be longer than 100 s. During this time, the array has a residual reading that belongs to an earlier exposure but that may be interpreted as part of a new exposure thereby introducing an uncontrolled error that may be difficult to correct. In addition, since the sensing element shows a reading that is removed from the baseline, any new exposure must be sufficiently large to exceed this residual reading thereby reducing the sensor sensitivity to future chemical exposures. Finally, since the ability of a sensing element to respond to any one or multiple exposures is limited, if the current reading is already above the baseline, the total amount of chemicals that the sensor can absorb is reduced and thus its dynamic range is reduced. Clearly, until the sensing element is restored to its baseline condition by desorbing the absorbed chemicals it cannot be used to reliably detect future chemical exposures.

Additionally, such absorbing polymers have been shown to exhibit extreme sensitivity to environmental conditions. In particular, water vapor readily absorbs in the polymer materials, often much more readily than the chemicals of interest. If the absolute humidity of the sampled air passing over the polymer array varies over time or from location to location, large drifts in the baseline state may be experienced. Additionally, the absorption of water into the polymers reduces the sensitivity of the polymer to chemicals of interest by decreasing the surface area available for chemical absorption. Further, it has been found that such polymers and other sensing elements are sensitive to the environmental temperature, the temperature of the sample gas drawn over them and changes in the temperatures of the sensing elements themselves. Any or all of these temperature changes may also be exhibited as a baseline drift. Such baseline drifts may be of magnitudes that are significantly larger than the changes associated with chemical presence and are of different magnitudes for each absorbing polymer in the polymer array. These large magnitude baseline variations make detection and identification of chemicals difficult when air, which may vary in absolute humidity and temperature (for example, in an HVAC system), is continuously sampled by such an in-situ device. Further, such variations completely mask the responses of the polymer array to any persistent low-concentration chemical presence.

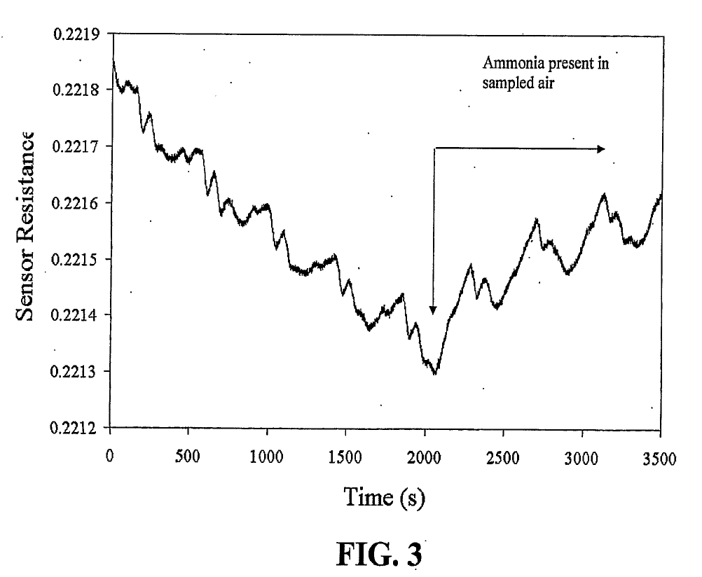

Such variations are exhibited in FIG. 3, where air from a test air duct where conditions could be controlled and monitored was continuously sampled and passed over the chemiresistor detector of the ENose device. The temperature and absolute humidity in the sampled air varied throughout the measurement. These changes in humidity and temperature are evidenced in FIG. 3 by the oscillatory nature of the sensor resistance and its decline from the start of this test until t=2000 s. The oscillation was attributed to a cooling coil in the air duct that was turned on and off periodically. When a chemical of interest was introduced into the sampled air at 2000 s, the resistance increased although the oscillations associated with the cooling coil are still evident. This oscillatory behavior, or the steady decline, are not seen when the sample air is at steady temperature and humidity. Clearly the response of the sensor to the introduction of the chemical of interest after 2000 s is visible. But if the concentration of the chemical of interest was smaller the response might have been masked by the drifts and oscillations seen in FIG. 3. Thus, the high frequency variations introduce noise that further reduces sensitivity to the presence of the chemical of interest. Without prior knowledge of when introduction of the chemical of interest occurred, it would be impossible to determine if the sensor resistance increase after 2000 s was due to environmental changes or to chemical presence.

FIG. 3 shows the response of a single in-situ detection element. For detection and identification of chemicals, such sampling devices rely on an array of sensing elements or polymer based detection elements. By design, each element of the array has a different sensitivity to different chemicals of interest. This sensitivity difference also causes the polymers of the array to respond differently (i.e., with different time responses or sensitivity) to environmental conditions, including the absolute humidity of the sampled air, pollutants, and polymer array temperature variations. The polymer response rates for absorption and desorption also vary with the chemical to be detected, the polymer temperature, and the presence of absorbed pollutants (such as water vapor, hydrocarbons, etc.). Since each polymer of the polymer array has a different sensitivity and absorption or desorption response rate that depends on numerous parameters, reliable and repeatable chemical fingerprints can be obtained only in well controlled environments.

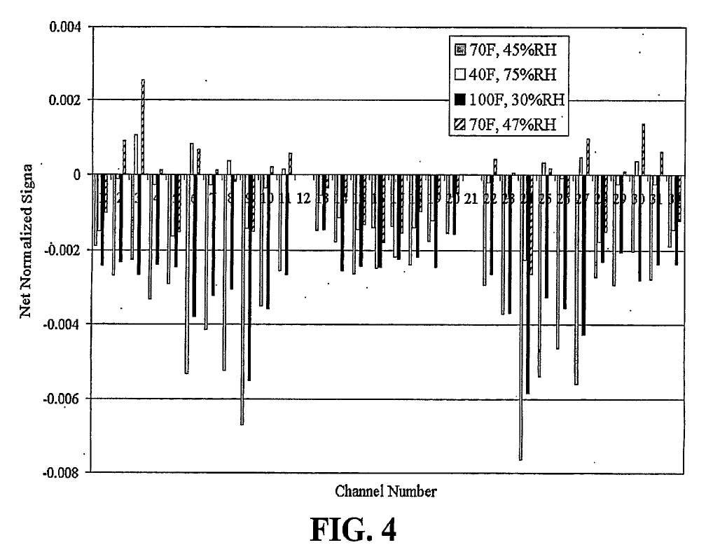

FIG. 4 shows the response of a thirty-two element polymer array to four introductions of the same chemical of interest into a test air duct maintained at different environmental conditions. Each bar in FIG. 4 represents the net-normalized (NNR) response of the polymer in the array, calculated as

$$N N R = \frac{Δ R}{R} = \frac{{R}_{S} - {R}_{B}}{{R}_{B}} \qquad ( 1 )$$

where R_{B} represents the output from the individual sensing element prior to chemical introduction and R_{S} represents the element output following chemical introduction. Referencing FIG. 3, R_{B} corresponds to a sample acquired prior to 2000 s while R₅ corresponds to a sample acquired after the chemical introduction at 2000 s. The NNR response represents the fractional deviation of a signal from a baseline level when a chemical of interest is present in the sampled air. The response itself (i.e., the electrical resistance of the element) and the NNR should increase with concentration; however, the NNR pattern as described by all of the sensing elements in the array should be the same when the same chemical of interest is presented.

FIG. 4 shows that using the continuous sampling method, where the sensing elements are continuously exposed to the sampled air, results in inconsistent NNR patterns for the same chemical. Notice that many elements, e.g., #6, exhibit both positive and negative NNR responses for ammonia. These inconsistent chemical patterns are the result of environmental drifts and the difference in response time of each polymer in the array. Such inconsistent patterns reduce, or as in FIG. 4 may prevent, the ability of any pattern recognition algorithm, such as, but not limited to, principal components analysis (PCA), canonical discriminate analysis (CDA), or neural network analysis (ANN), from identifying the chemical of interest. Finally, there is evidence to suggest that extended exposure to chemicals of interest and water vapor may degrade the polymer sensitivity to chemicals over time. Since the degradation of sensitivity is not uniform for all sensing elements of the sensor, the response of the entire sensor and consequently the fingerprints recorded for various chemical exposures may vary overtime. This in turn may render earlier calibrations and data libraries obsolete and require that the sensor be recalibrated and that a new data library unique to each individual sensor be generated and recorded.

To overcome the difficulties of reliably detecting and identifying chemicals as a result of using a continuous sampling mode, many in-situ sensors must be operated in a purge-sample cycle mode. During the purge cycle, the sensor is exposed to a gas, or other fluid, that does not contain chemicals that affect (e.g., interact or clog) any of the sensor's sensing components or accessories such as filters, drift tubes, concentrators, ionization chambers or when using polymers for sensing and detection, the purge fluid will be selected as not to absorb to the sensing elements. An example of such fluid may include clean noble gases like helium or argon, inert gases like nitrogen, or clean, dry air. With such exposure to a purge fluid, chemicals of interest and contaminants that are already absorbed to the sensing elements are partially or finally removed and the response of the sensing elements is partially or fully restored to the baseline response state to which future measurements may be reliably compared. In one embodiment, this purge cycle is achieved by switching a valve, either imbedded in the device or external to the device, that allows the purge fluid to flow over the sensing element array. This flow may come from bottles containing gas under high pressure, such as dry nitrogen or dry air, or if clean dry air is used, ordinary air from the ambient can be passed through a scrubber such as a column of activated charcoal and a column of dehumidifier substance such as DryRite desiccants. As illustrated in the embodiment of FIG. 1, for a long term continuous application, such as for monitoring a building HVAC system, a clean dry air flow may be achieved by passing ambient air, either from the sampled volume 10 or from a different air volume 12, through a single scrubbing column 30 containing a layer of desiccant 35 (to remove water vapor) and a layer of activated charcoal filter 36 (to remove chemical contaminants). The column may be replaced periodically or partially refreshed by an automated cleaning cycle that may include heating, backflow with certain cleansing substances, electrical discharge and similar processes.

Following this purge cycle, a sampling cycle is initiated. In one embodiment, a valve is switched to a position that closes the flow of purge fluid and connects the sensor's flow path to a line that is connected to a sampling probe. The flow of clean and dry air, or other fluid, is diverted or stopped while fluid from the sampled volume is directed to the sensor or over the sensing elements array for analysis. In many sensors the time to which the polymer is exposed to the sample fluid is shorter than the time to which it is exposed to the purge flow. But significant benefit can be achieved even when the purge time is shorter than the sample time.

To avoid baseline drifts due to temperature effects, the sampling line, the purge column, the purge fluid container, the lines connecting the column and/or the bottles to the sensor and the sensor itself may be temperature controlled by active means (heating and/or cooling), or may be installed in an environment where the temperature varies slowly (e.g., away from open windows, air inlets, or outside an air duct when used for the protection of HVAC system).

Purging restores partially or fully the baseline state of the sensing elements in the array. It also avoids contamination and degradation of the sensor's accessories or its sensing elements thereby extending the service life of the sensor, and preserves the accuracy and validity of earlier calibration results. Further, since the sensor elements such as the polymers are not continuously exposed to humidity and other contaminants for long periods of time, the sensor drifts due to environmental changes (FIG. 3) are minimized.

With this purge and sample mode of operation, a new data processing method must be devised to provide chemical identification capabilities. Currently available devices rely on simply computing the net normalized response of the polymers for a single purge-sample cycle, i.e., sensor operation is initiated by a single purge step followed by an indefinitely long sampling step. During this purge-sample cycle the resulting fingerprints are compared to a library database of previously obtained calibration fingerprints using a pattern recognition algorithm such as PCA, CDA, or ANN. However, the resulting net normalized response signatures may contain significant components that can be associated with water vapor or other atmospheric gases and pollutants and may be adversely affected by variations in the ambient temperature. Since some sensors are designed to sample air for extended periods of time, the concentration of water vapor or other atmospheric constituents may vary significantly from their initial value when the purge step occurred. To account for such possibilities, the pattern recognition algorithm must be trained to include the combination of the signature of the chemical of interest when combined with a wide variety of potential environmental conditions. Thus, the search space for the algorithm is large and the domain of possible library fingerprints associated with a single chemical is significant. With such a large fingerprint domain for a single chemical, it is possible that many chemicals may share a portion of or overlap each other in the fingerprint domain. This, in turn, reduces the ability of the selected pattern recognition algorithm to correctly and reliably identify the chemical of interest and at the same time requires a large library, complex algorithm, and long processing time.

In order to correctly and reliably identify the chemical of interest, the effect of water vapor, pollutants, and temperature variations must be removed from the resulting net normalized response fingerprint, or significantly reduced. If these effects can be removed or significantly reduced, the selected pattern recognition algorithm may be trained to recognize the pure fingerprints that represent the chemicals of interest. This significantly reduces the library search space and the volume occupied by a single chemical in the library fingerprint domain, reducing the potential for library fingerprint overlap thereby rendering the chemical identification more reliable.

A data processing method to remove or significantly reduce the effect of water vapor and other pollutant variations from the output of an array of in-situ sensors is described here. It relies on comparing the net normalized response of the in situ sensor from one purge-sample cycle to the response from an earlier purge-sample cycle. Preferably, when the device is started, it is set to be purged with the purge fluid. At the end of a pre-set purge duration, outputs from the sensor, such as from the polymer array, R_{B}, are measured and recorded, e.g., by digital storage means. Following this purge step, the sensor is set to sample fluid from the volume to be interrogated. During this first sample cycle, it is preferable that the interrogated volume does not contain any of the chemicals of interests (e.g., threat chemicals, characteristic interferants). However, the sampled volume may contain pollutants that normally occur in the environment where the sensor is installed. This step will elicit a response that differs from the baseline response obtained at the end of the purge step. At the end of this first sample time, responses of the sensor or its polymers, R_{S}, are recorded. In one embodiment, the net normalized response of each polymer in the polymer array is then computed, according to Equation 1. The NNR of all polymers in the array is considered to be a vector, S, whose dimension corresponds to the number of polymers in the array. Since this first purge-sample cycle is assumed to be free from chemicals of interest, it is considered a “clean” sample. This NNR vector is considered the reference vector, and will be subsequently denoted as S_{R}. Future purge-sample cycle NNR vectors are then compared to this reference vector. If they are similar to that vector they will indicate that the interrogated sample contains only background pollutants. But if it is distinguishably different from S_{R}, it will indicate that a new chemical of interest is present.

The NNR vector for subsequent purge-sample cycles are computed in a similar manner. However, subsequent sample cycles may contain a chemical of interest to be detected. To obtain the signature or fingerprint of a chemical introduced in subsequent sample cycles, the NNR sample response vector of the purge-sample cycle, S_{S}, must be compared to the reference vector. A simple method of comparison is to subtract the reference vector from the sample vector (S_{S}−S_{R}) to obtain the vector response of a chemical of interest in the sampled volume. However, this subtraction method assumes that the pollutant concentration in the sampled volume remained unchanged since the reference vector was recorded. If the pollutant concentration in the interrogated volume is likely to vary between purge-sample cycles an alternative processing method must be employed.

Many sensing elements exhibit a linear or nearly linear response to most chemicals, including water vapor; therefore, it is possible to use a vector projection method to account for environmental changes in the sampled volume. Since the response pattern to the pollutant remains the same, and only the magnitude of the pollutant response vector varies, it is possible to use an orthogonal projection approach to remove the effect of changing environmental conditions in the sampled volume. By projecting the NNR sample response vector on to the reference-vector, according to the following equation,

$$P = \frac{{S}_{S} \cdot {S}_{R}}{{‖ {S}_{R} ‖}^{2}} {S}_{R} \qquad ( 2 )$$

the vector component of the sample response vector along the reference response vector, P, is obtained. That is, the component of the sample response vector that is due to pollutant concentration is obtained by this projection, even if the pollutant concentration in the sample varies from the amount present in the reference purge-sample cycle. Subtracting this projection from the NNR sample vector, according to the following equation,

O=S_{S}−P (3)

gives the vector component O of the sample vector that is orthogonal to the reference vector. If there are no chemicals of interest present in the sampled volume, the components of this vector are near zero, indicating that only small pollutant concentrations are present. However, if a chemical of interest is present in the interrogated volume, this orthogonal vector component is the fingerprint of the chemical of interest in the sampled volume.

Equations 2 and 3 represent a technique for nulling the effects of environmental and pollutant variations assuming that the element responses are linear with the chemical of interest or pollutant concentration. For many devices, small changes in the chemical of interest or pollutant concentrations may be described well by such a linear model. However, for some sensors, or chemical of interest or pollutant concentrations, such a linear model may not be appropriate. Under such circumstances, removing the effects of environmental and pollutant variations may require the use of non-linear or iterative mathematical techniques. Selection of non-linear techniques must account correctly for mathematical dependence that describes such non-linearity. For example, for optical absorption sensing techniques the non-linearity is determined by Beer's law and therefore can be accounted for by a method that was described previously by Lewin et al., “Analysis Methods for Unmixing of the Response of Non-Linear, Cross-Reactive Sensors and Related System to Single and Multiple Stimulants,” PCT/US2006/010405, of which is incorporated by reference herein in its entirety, including methods, devices and systems disclosed therein that may be implemented with the present invention.

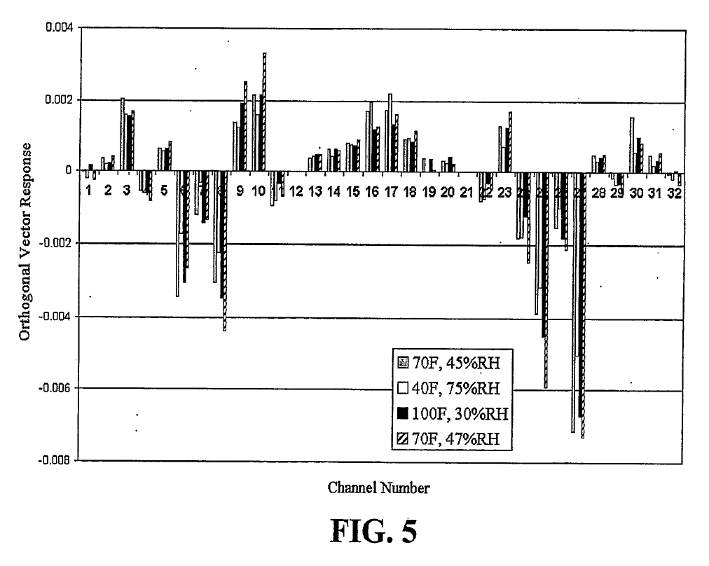

FIG. 5 shows the results of such a processing method for ammonia, the same chemical of interest presented in FIGS. 3 and 4. Notice that the signature is more consistent and repeatable than the signature shown in FIG. 4, even though the environmental conditions varied significantly. With this consistent response, it is much more likely that any algorithm that attempts to match this signature against a pre-recorded signature will be able to properly identify the presence of a chemical of interest.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A detection system for detecting chemicals in fluids, said system comprising:
at least one in-situ sensor comprised of one or more detection elements adapted to detect at least one chemical;
a purge fluid input means, wherein said purge fluid can be inputted into said sensor either for a predetermined and set time period or for an indefinite time period;
a sampling input means, wherein the sample fluid of interest can be inputted into said sensor either for a predetermined and set time period or for an indefinite time period; and
a means for alternating between a purging period and a sampling period.

2. The system of claim 1, wherein:
said purge fluid can be inputted into said sensor for a predetermined and set time period; and
said sample fluid of interest is inputted into said sensor for a predetermined and set time period.

3. The system of claim 1, wherein:
said purge gas can be inputted into said sensor for an indefinite time period;
said sample fluid of interest is inputted into said sensor for an indefinite time period; and means are provided to correct for the effects of varying absorption rates of the sample fluid on the various elements of said sensor and for the effects of the various desorption rates from the various elements of said sensor.

4. The system of any one of claims 1, 2, or 3, further comprising at least one data processor adapted to receive data from said at least one in-situ sensor, wherein said data processor stores data from each said purging period and said sampling period.

5. The system of claim 4, wherein said data processor computes the response of the in-situ sensor detection elements as the difference or the normalized difference between the purge and sample data.

6. The system of claim 5, wherein said data processor nulls the sensor response due to environmental conditions by subtracting the response of a previous purge and sample cycle or cycles from the current purge and sample cycle response.

7. The system of claim 5, wherein said data processor nulls the sensor response due to environmental condition variations by means of a linear technique, including, but not limited to, linear or orthogonal projection techniques.

8. The system of claim 5, wherein said data processor nulls the sensor response due to environmental condition variations by means of a non-linear or iterative technique.

9. The system of claim 6, wherein said data processor detects and identifies the chemical by comparing the result of the subtraction to a database of previously obtained sensor responses using a pattern recognition technique, including, but not limited to, least-squares techniques, matched filter techniques, orthogonal subspace projection (OSP), principal components analysis (PCA), canonical discriminates analysis (CDA), and artificial neural network (ANN) techniques.

10. The system of claim 7, wherein said data processor detects and identifies the chemical by comparing the result of said linear technique to a database of previously obtained sensor responses using a pattern recognition technique, including, but not limited to, least-squares techniques, matched filter techniques, orthogonal subspace projection (OSP), principal components analysis (PCA), canonical discriminates analysis (CDA), and artificial neural network (ANN) techniques.

11. The system of claim 8, wherein said data processor detects and identifies the chemical by comparing the result of said non-linear technique to a database of previously obtained sensor responses using a pattern recognition technique, including, but not limited to, least-squares techniques, matched filter techniques, orthogonal subspace projection (OSP), principal components analysis (PCA), canonical discriminates analysis (CDA), and artificial neural network (ANN) techniques.

12. The system any one of claims 1, 2, or 3, wherein said purge fluid input means comprises a pumping mechanism imbedded in the in-situ sensor.

13. The system any one of claims 1, 2, or 3, wherein said purge fluid input means comprises a pumping mechanism external to the in-situ sensor.

14. The system any one of claims 1, 2, or 3, wherein said purge fluid input means comprises at least one of a dessicating and a purifying agent, thereby dessicating and/or purifying the purge fluid.

15. The system any one of claims 1, 2, or 3, wherein said purge fluid input means comprises a dessicating agent and a purifying agent and wherein the purge fluid is taken from the volume of interest to be sampled, thereby better eliminating the baseline drift by accounting for changes in the environmental conditions including temperature and humidity.

16. The system any one of claims 1, 2, or 3, wherein the sample fluid and said purge fluid are drawn through a tube that allows the temperature of the fluids entering said sensor to equilibrate with the environment, thereby reducing the effects of temperature drifts.

17. The system any one of claims 1, 2, or 3, further comprising at least one temperature control device that allows the temperature of the fluids entering the sensor and/or the temperatures of the sensing elements to reach a predetermined temperature, thereby reducing the effects of temperature drifts.

18. A method for detecting chemicals, said method comprising:
in-situ monitoring a fluid volume for detecting at least one chemical;
purging during a purging period, wherein the duration of said purging period is either a predetermined and set time period or an indefinite time period;
sampling from the fluid volume of interest during a sampling period, wherein the duration of said sampling period is either a predetermined and set time period or an indefinite time period; and
switching between said purging period and said sampling period to create a purge-sample cycle, wherein said purge-sample cycle can repeat any number of times.

19. The method of claim 18, wherein:
said purging period comprises inputting a purge fluid, wherein said purge fluid can be inputted for a predetermined and set time period; and
said sampling period comprises inputting said sample from said fluid volume of interest, wherein said sample is inputted for a predetermined and set time period.

20. The method of claim 18, wherein:
said purging period comprises inputting a purge fluid, wherein said purge fluid can be inputted for an indefinite time period;
said sampling period comprises inputting said sample from said volume of interest, wherein said sample is inputted for an indefinite time period; and
means are provided to correct for the effects of varying absorption rates of the sample fluid on the various elements of said sensor and for the effects of the various desorption rates from the various elements of said sensor.

21. The method of any of claims 18, 19, or 20, further comprising processing data from said purge-sample cycles, wherein said processing comprises measuring the response of the detection elements of an in-situ sensor.

22. The method of claim 21, wherein said processing further comprises computing said response of said in-situ sensor detection elements as the difference or the normalized difference between the data from the purging period and the data from the sampling period of said purge-sample cycles.

23. The method of claim 22, wherein said processing nulls the response of said detection elements due to environmental conditions by subtracting the response of a previous purge-sample cycle or cycles from the current purge-sample cycle response.

24. The method of claim 22, wherein said processing nulls the response of said detection elements due to environmental condition variations by means of a linear technique, including, but not limited to, linear or orthogonal projection techniques.

25. The method of claim 22, wherein said processing nulls the response of said detection elements due to environmental condition variations by means of a non-linear or iterative technique.

26. The method of claim 23, wherein said processing detects and identifies the chemical by comparing the result of said subtracting to a database of previously obtained sensor responses using a pattern recognition technique, including, but not limited to, least-squares techniques, matched filter techniques, orthogonal subspace projection (OSP), principal components analysis (PCA), canonical discriminates analysis (CDA), and artificial neural network (ANN) techniques.

27. The method of claim 24, wherein said processing detects and identifies the chemical by comparing the result of said linear technique to a database of previously obtained sensor responses using a pattern recognition technique, including, but not limited to, least-squares techniques, matched filter techniques, orthogonal subspace projection (OSP), principal components analysis (PCA), canonical discriminates analysis (CDA), and artificial neural network (ANN) techniques.

28. The method of claim 25, wherein said processing detects and identifies the chemical by comparing the result of said non-linear technique to a database of previously obtained sensor responses using a pattern recognition technique, including, but not limited to, least-squares techniques, matched filter techniques, orthogonal subspace projection (OSP), principal components analysis (PCA), canonical discriminates analysis (CDA), and artificial neural network (ANN) techniques.

29. The method of claim 19, wherein said purge fluid passes through at least one of a dessicating and a purifying agent.

30. The method of claim 20, wherein said purge fluid passes through at least one of a dessicating and a purifying agent.

31. The method of claim 29, wherein said purge fluid is taken from the volume of interest, thereby helping to eliminate the baseline drift by accounting for changes in the environmental conditions including temperature and humidity.

32. The method of claim 30, wherein said purge fluid is taken from the volume of interest, thereby helping to eliminate the baseline drift by accounting for changes in the environmental conditions including temperature and humidity.

33. The method of claim 19, wherein the sample fluid and said purge fluid are drawn through a tube that allows the temperature of the fluids entering said sensor to equilibrate with the environment, thereby reducing the effects of temperature drifts.

34. The method of claim 20, wherein the sample fluid and said purge fluid are drawn through a tube that allows the temperature of the fluids entering said sensor to equilibrate with the environment, thereby reducing the effects of temperature drifts.

35. The method of claim 19, further comprising at least one temperature control device that allows the temperature of the fluids entering the sensor and/or the temperatures of the sensing elements to reach a predetermined temperature, thereby reducing the effects of temperature drifts.

36. The method of claim 20, further comprising at least one temperature control device that allows the temperature of the fluids entering the sensor and/or the temperatures of the sensing elements to reach a predetermined temperature, thereby reducing the effects of temperature drifts.
